(19) United States
(12) Patent Application Publication
(10) Pub. No.: US 2007/0135149 A1
(43) Pub. Date: Jun. 14, 2007

(54) Method and system for synchronizing in a communication system

(75) Inventors: Ki-Won Sung, Suwon-si (KR); Seung-Yong Ham, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/636,939

(22) Filed: Dec. 11, 2006

(30) Foreign Application Priority Data
Dec. 9, 2005 (KR) 10-2005-120704

(51) Int. Cl. H04B 7/00

(52) U.S. Cl. 455/502; 455/12.1

(57) ABSTRACT

A method and system for synchronizing between base stations controlling different cells in a communication system. The method includes receiving, by a base station, a reference signal from an external system and generating a first frame number according to the received reference signal, and generating a second frame number by adding a specific number for each base station of a plurality of base stations to the first frame number, and broadcasting a message setting second frame number to mobile stations.

### PRIORITY

This application claims the priority under 35 U.S.C. §119(a) to an application filed in the Korean Intellectual Property Office on Dec. 9, 2005 and assigned Serial No. 2005-120704, the contents of which are incorporated herein by reference.

### BACKGROUND OF THE INVENTION

1. Field of the Invention

The present invention relates to a communication system, and more particularly to a method and system for synchronizing in a communication system.

2. Description of the Related Art

The next generation communication systems are being developed to provide users with services having various qualities of service (QoS) at a high transmission speed. Accordingly, for these generation communication systems, research is being undertaken to develop systems which can support a high speed service capable of guaranteeing mobility and QoS in a Broadband Wireless Access (BWA) communication system such as a wireless Local Area Network (LAN) system and a wireless Metropolitan Area Network (MAN) system. Representative communication systems resulting from such research include the IEEE (Institute of Electrical and Electronics Engineers) 802.16a/d communication system and the IEEE 802.16e communication system.

The IEEE 802.16a/d communication system and the IEEE 802.16e communication system employ an Orthogonal Frequency Division Multiplexing (OFDM)/Orthogonal Frequency Division Multiple Access (OFDMA) scheme, in order to support a broadband transmission network for a physical channel of the wireless MAN system. The IEEE 802.16a/d communication system currently reflects only a single cell structure and only a state in which subscriber stations are fixed, without reflecting mobility of a Subscriber Station (SS) at all. However, the IEEE 802.16e communication system reflects mobility of an SS. As used herein, an SS having mobility is referred to as a Mobile Station (MS).

Meanwhile, because the IEEE 802.16e communication system, which is a BWA communication system, takes the mobility of an MS into account, power consumption of the MS plays an important part in the entire system. Therefore, an idle mode operation and an awake mode operation corresponding to the idle mode operation have been proposed for the MS station and a Base Station (BS) in order to minimize the power consumption of the MS. The idle mode in the IEEE 802.16e communication system has been proposed in order to minimize power consumption of an MS in an idle interval during packet data transmission, in which packet data is not transmitted. That is, in the idle mode, both the MS and the BS shift their operation modes into the idle mode, thereby minimizing the power consumption of the MS in the idle interval in which the packet data is not transmitted.

In general, the packet data is transmitted using a transmission burst when it is generated. Accordingly, the same operation cannot be performed in both an interval during in which the packet data is not transmitted and during an interval in which packet data is transmitted. For this reason, the idle mode operation as described above has been proposed. Meanwhile, if packet data to be transmitted is generated when both the MS and the BS are in the idle mode, the MS and the BS must simultaneously state-transit into the awake mode and must transmit/receive the packet data. The idle mode operation as described above is proposed with regard to power consumption and minimizing interference between channel signals. However, since traffic has a large influence on the packet data, the idle mode operation must be performed in consideration of traffic and transmission scheme characteristics of the packet data.

Further, in a typical BWA communication system having a cell structure, one BS controls one cell in order to support the mobility of an MS, and the BS provides a service to MSs located within the cell. The MS may move from a current cell, in which the MS currently receives a service, to a neighbor cell. Then, the MS must perform handover from a serving BS (a BS controlling the current cell) to a target BS (a BS controlling the neighbor cell).

FIG. 1 is a block diagram illustrating a structure of a typical BWA communication system.

Referring to FIG. 1, the BWA communication system has a multi-cell structure including cell1 110 and cell2 120, and includes BS1 111 and BS2 121 controlling the cells 110 and 120, and an MS 113 which can receive a service from the BSs 111 and 121. The signal transmission/reception between the BSs 111 and 121 and the MS 113 is performed using the OFDM/OFDMA scheme. Further, the BSs 111 and 121 receive a Global Positioning System (GPS) signal from a GPS 101 and then synchronize the frame numbers by using the received GPS signal.

Although not shown, frames of the BWA communication system include a downlink (DL) frame and an uplink (UL) frame. The DL frame includes a preamble area, a DL MAP (DL_MAP) area/UL MAP (UL_MAP) area, a Partial Usage of Sub-Channels (PUSC) area, and a Full Usage of Sub-Channels (FUSC) area. The UL frame includes a PUSC area.

The preamble area carries a preamble sequence for acquiring synchronization between the BS and the MS, and the DL_MAP/UL_MAP area carries a DL_MAP message or a UL_MAP message. The BS transmits to each MS a MAP message indicating a channel interval allocated to the MS before the allocated channel interval. Each MS recognizes a channel interval and a coding scheme, etc, which are allocated to the MS, by detecting information included in the MAP message. The DL_MAP message and the a UL_MAP message will be described later in more detail. The PUSC area carries DL data burst by using a PUSC scheme, and the FUSC area carries DL data burst by using an FUSC scheme. Further, the PUSC area carries UL data burst by using a PUSC scheme.

Meanwhile, in consideration of the mobility of the MS 113, the BWA communication system employs switching between an idle mode and an awake mode in order to reduce the power consumption by the MS 113 as described above. To this end, the idle mode includes paging intervals, in each of which the MS 113 wakes up and checks if there is any paging. When the MS 113 moves from cell1 110 controlled by BS1 111 (the serving BS) to cell2 120 controlled by BS2 121 (a neighbor BS) while the MS 113 is in the idle mode, if the frame number of BS2 121 controlling cell2 120 after the movement is different from the frame number of BS1 111 controlling cell1 110 before the movement, the paging time point must be calculated again because the paging time point changes. Such re-calculation may cause loss of paging information and may increase operational loads on the system. Therefore, BS1 111 and BS2 121 receive a GPS signal from the GPS 101 as described above and synchronize the frame numbers by using the GPS signal.

Further, because the BWA communication system takes the mobility of the MS 113 into consideration, the MS 113 performs handover when it moves from cell1 110 to cell2 120 in the awake mode. During the handover, when the target BS, to which the MS 113 will move, transmits a Fast_Ranging-IE message including a fast ranging Information Element (IE) to the MS 113 for the fast ranging, the MS 113 transmits a ranging request (RNG-REQ) message to the target BS without competition. Then, for the fast ranging, the target BS must inform the serving BS of the time point at which the target BS will transmit the Fast_Ranging-IE message to the MS 113. Then, the serving BS informs the MS of the time point at which the target BS will transmit the Fast_Ranging-IE message to the MS. In informing the time point for transmitting the Fast_Ranging-IE message, the communication system uses the frame numbers of the serving BS and the target BS as reference time. That is, the communication system synchronizes the frame numbers of the BSs 111 and 121 by using the GPS signal and then informs the time point for transmitting the Fast_Ranging-IE message by using the synchronized frame numbers as reference time.

However, in the case of subcarrier randomization in modulation of the BWA communication system according to the synchronization between the frame numbers of the BSs as described above, modulation in each BS is randomized by a specific Pseudo-Random Bit Sequence (PRBS) of the BS. For example, it is assumed that an initialization vector of the PRBS includes a total of eleven bits as shown in Table 1 below.

TABLE 1
b0 ˜ b4: downlink - five Least Significant Bits (LSBs) of IDcell in the
first PUSC zone
or DL PermBase in other zones, and

uplink - five LSBs of IDcell;
b5 ˜ b6: downlink - segment number + 1, and
uplink - 0b11, that is, all bits have a value of 1; and

b7 ˜ b10: downlink - 0b1111, that is, all bits have a value of 1, and

uplink - four LSBs of frame numbers.

Then, in the case of downlink, which has 32 types of IDcell or PermBase and three types of segment numbers, total 96 initialization vectors are generated. In the case of uplink, in which the initialization vectors are generated by the IDcell and frame numbers, total 32 types of initialization vectors are generated when the frame numbers of the BSs have been synchronized. Therefore, it is possible to generate 32 types of PRBSs in the uplink, and the possibility that two or more adjacent BSs may perform the same randomization thus becomes three times higher in the uplink than in the downlink. Hereinafter, the case in which two or more adjacent BSs perform the same randomization will be described in more detail.

For example, when b0˜b10 of a BS is “10101010101,” the initialization sequence is “101010101000000000 . . . . ” When the initialization sequence is subjected to a PRBS generator having a polynomial as defined by Equation (1) below, a randomization sequence of the corresponding BS is produced.
y=x¹¹+x⁹+1 (1)

If the randomization sequence produced by Equation (1) is described as w0, w1, w2, . . . , randomization sequences as many as available sub-carriers are generated and used for randomization of the modulation. In the case of 1024 Fast Fourier Transform (FFT) and PUSC, a sequence of w0, w1, . . . , w840 is used for the first symbol, and a sequence of w1, w2, . . . , w841 is used for the second symbol. Further, a data block having been subjected to repetition of the randomization sequence is subjected to a constellation mapping and is then mapped to physical sub-carriers. At this time, before the physical sub-carrier mapping, if each sub-carrier has an index of k, a factor of

$$2 \times ( \frac{1}{2} - {w}_{k} )$$

is multiplied by the constellation.

As a result, when the randomization by two or more BSs is the same, the constellation mapping of the BSs is also the same. When the constellation mapping of the BSs is the same, problems may occur during demodulation. For example, the performance in pilot estimation may be largely degraded. In other words, in the uplink, each MS transmits the pilot at the same position, and the pilot signal is determined by the randomization sequence, that is, wₖ. Therefore, each MS served by different BSs transmits pilots having the same sequence, so that the pilot estimation by the BSs may be degraded, thereby causing corresponding errors in the demodulation.

As described above, when the randomization by two or more BSs is the same, demodulation errors may be produced. When the frame numbers of the BSs have been synchronized, 32 types of uplink randomization sequences exist as described above. More specifically, if each cell controlled by a single BS includes two or more sectors, BSs using the same PRBS necessarily exist within 2 tiers. As a result, the uplink may be subject to more demodulation errors than the downlink. Accordingly, the communication quality may be lower in the uplink than the downlink. Therefore, it is necessary to use different frame numbers for adjacent BSs. However, according to the conventional method, in which the frame numbers are randomly allocated to BSs without a rule, there may occur many problems in relation to synchronization between the frame numbers as described above when an MS moves frame a cell controlled by a serving BS to another cell controlled by another BS.

### SUMMARY OF THE INVENTION

Accordingly, the present invention has been made to solve the above-mentioned problems occurring in the prior art, and an object of the present invention is to provide a method and system for synchronization between base stations controlling different cells in a communication system.

It is another object of the present invention to provide a method and system for synchronizing frame numbers between base stations controlling different cells in a communication system.

It is another object of the present invention to provide a method and system for setting frame numbers of base stations controlling different cells in a communication system.

In accordance with the present invention, there is provided a method for synchronization in a communication system. The method includes receiving, by a base station, a reference signal from an external system and generating a first frame number according to the received reference signal, and generating a second frame number by adding a specific number for each base station of a plurality of base stations to the first frame number, and broadcasting a message setting second frame number to mobile stations.

In accordance with the present invention, there is provided a method for synchronization in a communication system. The method includes receiving messages from base stations by a mobile station, wherein each of messages includes a second frame number generated by adding a specific number for each base stations to a first frame number, and recognizing the second frame number and performing randomization according to the second frame number.

In accordance with the present invention, there is provided a method for synchronizing in a communication system. The method includes receiving, by a base station, reference information from an external system and generating a message according to the reference information and predetermined information for each base stations of a plurality of base stations, and broadcasting the generated message to the plurality of mobile stations.

In accordance with the present invention, there is provided a system for synchronizing in a communication system. The system includes a base station for generating a first frame number according to a reference signal when the base station receives the reference signal from an external system, generating a second frame number by adding a specific number for each base stations of a plurality of base stations to the first frame number, and broadcasting a message setting the generated second frame number to a plurality of mobile stations, and a mobile station for recognizing the second frame number set in the message when the mobile station receives the message from the base station, and performing randomization according to the second frame number.

In accordance with the present invention, there is provided a system for synchronizing in a communication system. The system includes a base stations for receiving a reference information from an external system and generating a message according to the reference information and predetermined information for each base stations of a plurality of base stations, and broadcasting the generated message to the plurality of mobile stations.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a typical BWA communication system;

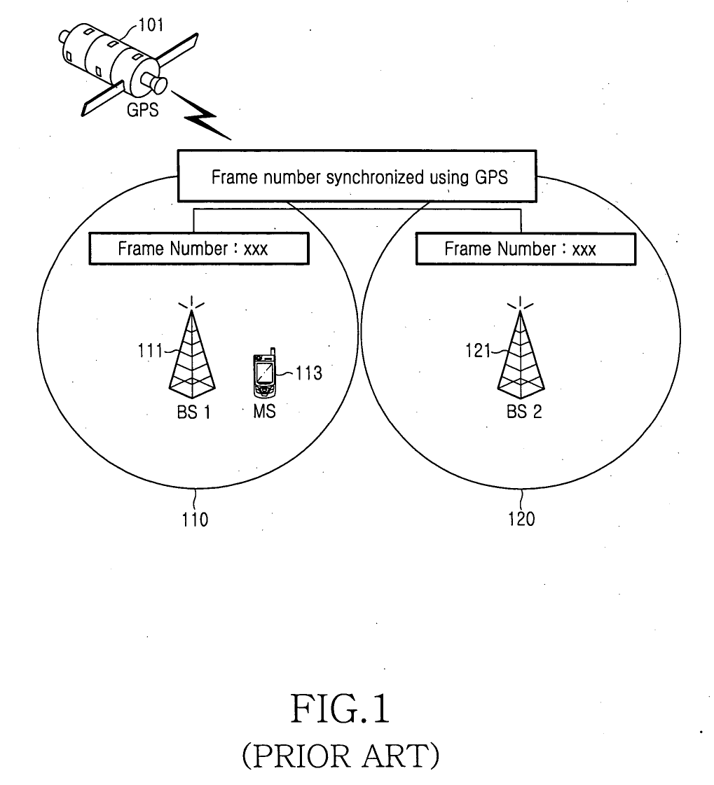

FIG. 2 is a block diagram illustrating a structure of a BWA communication system according to the present invention;

FIG. 3 is a flowchart illustrating an operational process of a BS in a BWA communication system according to the present invention;

FIG. 4 is a flowchart illustrating an operational process of an MS in a BWA communication system according to the present invention;

FIG. 5 is a flow diagram illustrating a handover process in a BWA communication system according to the present invention; and

FIG. 6 is a is a flow diagram illustrating a paging process by an MS in an idle mode in a BWA communication system according to the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention rather unclear.

The present invention provides a method and system for synchronizing in a communication system, for example, a Broadband Wireless Access (BWA) communication system, such as the Institute of Electrical and Electronics Engineers (IEEE) 802.16 communication system. Further, the present invention provides a method and system for synchronizing frame numbers between Base stations (BSs) controlling different cells in a communication system. Although the present invention is according to an IEEE 802.16 communication system, the method and system for synchronizing of the present invention can be applied to other communication systems.

Further, for a communication system in which it is necessary both to synchronize frame numbers of the BSs and to prevent synchronization of the frame numbers of the BSs, the present invention provides a method and system for synchronizing frame numbers, in which a first frame number is used to synchronize the frame numbers of the BSs and a second frame number is used to prevent synchronization of the frame numbers of the BSs. To this end, the present invention provides a system and method for synchronizing frame numbers of the BSs, in which the frame number of the BS is divided into a virtual frame number (first frame number) and an actual frame number (second frame number), and the actual frame number (second frame number) is constructed by adding a segment number, which is a predetermined offset for each BS, to the virtual frame number (first frame number).

Therefore, because the frame number of the BS is divided into a virtual frame number and an actual frame number using the segment number, the virtual frame number can be used to synchronize the frame numbers of the BSs and the actual frame number (more specifically, the segment number) can be used to prevent synchronization of the frame numbers of the BSs. As a result, the present invention provides synchronization between frame numbers of the BSs (for example, in the case of randomization in the BWA communication system) and prevents synchronization of the frame numbers of the BSs (for example, in the case where a Mobile Station (MS) moves between cells controlled by different BSs).

The following description discloses a scheme for synchronizing frame numbers by a BS and an MS in the BWA communication system according to the present invention. Specifically, an operation for generating the virtual frame number, the segment number, and the actual frame number. Further, the MS using the service from the BS has both stationary and mobility. Also, the following description discloses a method for using the frame numbers according to the present invention. That is, the actual frame numbers obtained when the MS performs handover for receiving service from a target BS, which occurs without interruption due to movement of the MS from a cell controlled by a serving BS to a cell controlled by the target cell.

Further, as described above, in order to minimize the power consumption of an MS, the BWA communication system includes an idle mode and an awake mode for the MS and the BS. The following description discloses an operation of using the frame numbers, that is, the actual frame numbers, when an MS in the idle mode moves between cells controlled by different BSs.

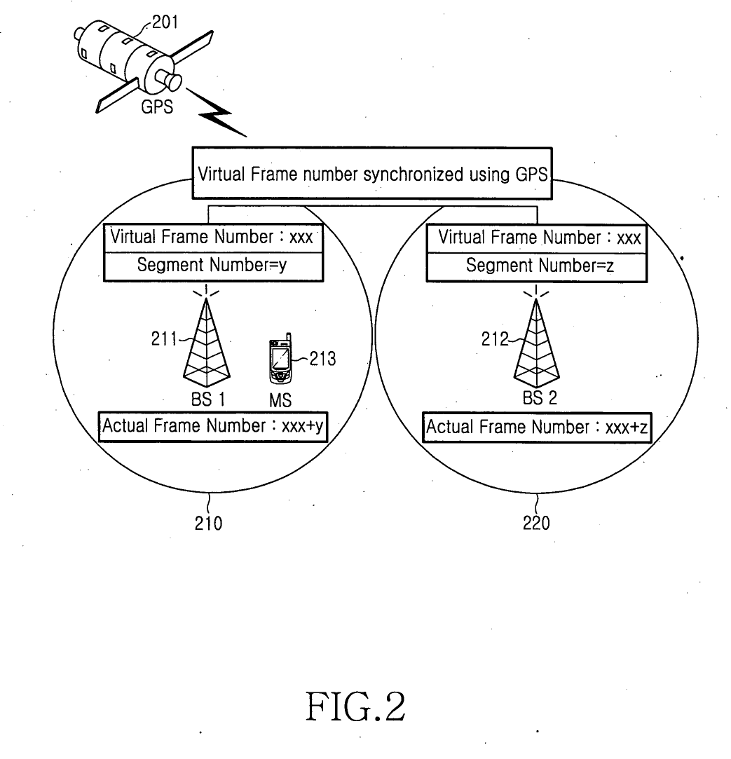

FIG. 2 is a block diagram illustrating a structure of a BWA communication system according to the present invention.

Referring to FIG. 2, the BWA communication system includes a multi-cell structure including cell1 210 and cell2 220, and includes BS1 211 and BS2 221 controlling the cells 210 and 220, and an MS 213 which can receive a service from the BSs 211 and 221. It is assumed that the signal transmission/reception between the BSs 211 and 221 and the MS 213 is performed using an Orthogonal Frequency Division Multiplexing/Orthogonal Frequency Division Multiple Access (OFDM/OFDMA) scheme. Further, each of the BSs 211 and 221 receives a Global Positioning System (GPS) signal from a GPS 201 and generates a first frame number, which is a virtual frame number, by using the received GPS signal.

At each frame, the BSs 211 and 221 generate the virtual frame number (first frame number) by using the received GPS signal. The generated virtual frame number is “xxx” in both the BS 211 and the BS 221. Therefore, the BSs 211 and 221 are automatically synchronized with the virtual frame number. In other words, the frame numbers of the BSs 211 and 221 are synchronized by the virtual frame number (first frame number) generated according to the GPS signal. Meanwhile, the BSs 211 and 221 generate actual frame numbers for themselves by adding their segment numbers to the virtual frame number, respectively. Specifically, the BS 211 generates its own actual frame number xxx+y (the second frame number) by adding its segment number y to the virtual frame number xxx, and the BS 221 generates its own actual frame number xxx+z (the second frame number) by adding its segment number z to the virtual frame number xxx. The actual frame number can be defined by Equation (2) below.
Actual Frame Number=Virtual Frame Number+Segment Number (2)

In Equation (2), the segment number refers to a specific parameter of each BS, which has one value from among 0, 1, and 2. The segment number is transmitted by a preamble Pseudo Noise (PN) code. Further, the actual frame number of each BS can be divided into the virtual frame number and the segment number. The virtual frame number is used to synchronize the actual frame number of each BS, and the segment number is used to prevent synchronization of the actual frame number of each BS.

Although not shown, a frame of the BWA communication system includes a downlink (DL) frame and an uplink (UL) frame. The DL frame includes a preamble area, a DL MAP (DL_MAP) area/UL MAP (UL_MAP) area, a Partial Usage of Sub-Channels (PUSC) area, and a Full Usage of Sub-Channels (FUSC) area. The UL frame includes a PUSC area.

The preamble area carries a preamble sequence for acquiring synchronization between the BS and the MS, and the DL_MAP/UL_MAP area carries a DL_MAP message or a UL_MAP message. The BS transmits to each MS a MAP message indicating a channel interval allocated to the MS before the allocated channel interval. Each MS recognizes a channel interval and a coding scheme, etc, which are allocated to the MS, by detecting information included in the MAP message. The DL_MAP message and the a UL_MAP message will be described in more detail below. The PUSC area carries DL data burst by using a PUSC scheme, and the FUSC area carries DL data burst by using an FUSC scheme. Further, the PUSC area carries UL data burst by using a PUSC scheme.

The DL_MAP message has a format as defined by Table 2 below.

TABLE 2

| | | |
|---|---|---|
| Syntax | Size | Notes |

DL-MAP_Message_Format( ) {

| | | |
|---|---|---|
| Management Message Type = 2 | | |
| PHY Synchronization Field | variable | See appropriate PHY |
| | | specification. |
| DCD Count | 8 bits | |
| Base Station ID | 48 bits | |
| Begin PHY specific Section { | | See applicable PHY |
| | | section. |

| | |
|---|---|
| For (i = 1; i <= n; i++) { | For each DL-MAP ele- |
| | ment 1 to n. |

| | | |
|---|---|---|
| DL-MAP_IE( ) | variable | See corresponding PHY |
| | | specification. |

}

}
if! (byte boundary) {

Referring to Table 2, the DL_MAP message includes a plurality of Information Elements (IEs), which include a Management Message Type field indicating the type of the transmitted message, a PHYsical (PHY) synchronization field indicating specifications set in accordance with the modulation scheme and demodulation scheme applied to the physical channel in order to acquire synchronization, a DCD count field indicating a count corresponding to change in a configuration of a Downlink Channel Descriptor (DCD) message including a downlink burst profile, a Base Station ID field indicating a base station identifier, and n number of DL_MAP IEs.

The UL_MAP message has a format as defined by Table 3 below.

TABLE 3

| | | |
|---|---|---|
| Syntax | Size | Notes |

UL-MAP_Message_Format( ) {

| | | |
|---|---|---|
| Management Message Type = 3 | 8 bits | |
| Uplink Channel ID | 8 bits | |
| UCD Count | 8 bits | |
| Allocation Start Time | 32 bits | |
| Begin PHY Specific Section { | | See applicable PHY |
| | | section. |

| | |
|---|---|
| for (i = 1; i <= n; i++) { | For each UL-MAP ele- |
| | ment 1 to n. |

| | | |
|---|---|---|
| UL-MAP_IE( ) | variable | See corresponding PHY |
| | | specification. |

}

}
if! (byte boundary) {

| | | |
|---|---|---|
| Padding Nibble | 4 bits | Padding to reach byte |
| | | boundary |

}

}

Referring to Table 3, the UL_MAP message includes a plurality of IEs, which include a Management Message Type field indicating the type of the transmitted message, an Uplink channel ID field indicating a used uplink channel identifier, a UCD count field indicating a count corresponding to change in a configuration of an Uplink Channel Descriptor (UCD) message including an uplink burst profile, an Allocation Start Time field indicating uplink resource allocation start information, and n number of DL_MAP IEs. The uplink channel identifier is assigned a single value in a Medium Access Control (MAC) sub-layer.

The PHY synchronization field of the DL_MAP message has a format as defined by Table 4 below.

TABLE 4

| | | |
|---|---|---|
| Syntax | Size | Notes |

PHY synchronization_field( ) {

| | |
|---|---|
| Frame duration code | 8 bits |
| Frame number | 24 bits |

}

Referring to Table 4, the PHY synchronization field includes a Frame duration code field indicating the frame duration code, and a Frame number field indicating the frame number. The Frame duration code field has a size of 8 bits and has frame duration according to frame duration codes as shown in Table 5 below. Further, the Frame number field has a size of 24 bits, and increases 1 by each frame. The actual frame number according to the present invention is set in the Frame Number field. The DL_MAP message in which the actual frame number has been set as described above is broadcasted as a broadcast message to MSs in a cell.

TABLE 5

| Frame duration code (4 bits) | Frame duration (T_{F}) | Units |
|---|---|---|
| 0x01 | 0.5 | ms |
| 0x02 | 1 | ms |
| 0x03 | 2 | ms |
| 0x04 - 0x0F | reserved | |

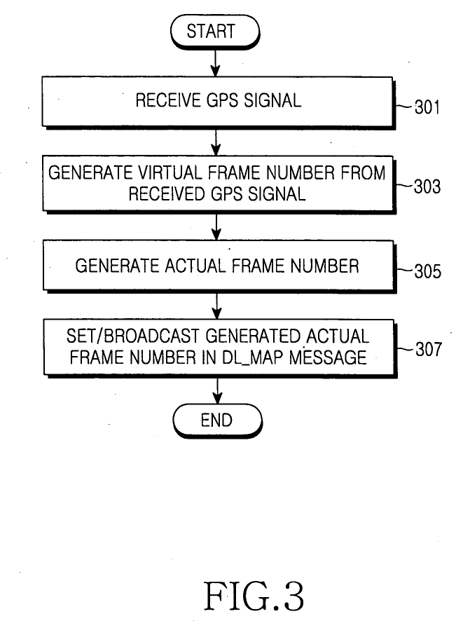

FIG. 3 is a flowchart illustrating an operation process of a BS in a BWA communication system according to the present invention.

Referring to FIG. 3, the BS receives a GPS signal from the GPS at each frame in step 301, and generates a virtual frame number (first frame number) by using the received GPS signal in step 303. By the generated virtual frame number, synchronization is acquired at each frame between the BSs (or the frames of the BSs) receiving the GPS signal. Then in step 305, the BS adds a segment number, which is an offset already determined for the BS itself, to the virtual frame number generated in step 303, thereby generating the actual frame number (second frame number).

The actual frame number generated in step 305, which is the frame number for the BS itself, includes the virtual frame number of the segment number as defined by Equation (2). Further, in the actual frame number, the segment number is used to prevent the synchronization between frame numbers of the BSs, and the virtual frame number is used for the synchronization between frame numbers of the BSs. Then in step 307 the actual frame number, which is the frame number of the BS generated in step 305, is set in the PHY synchronization field of the DL_MAP message of Table 2, which is then broadcasted to the MSs, as described above.

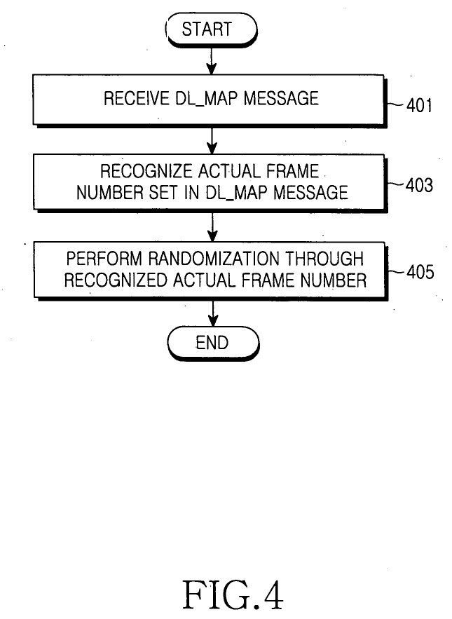

FIG. 4 is a flowchart illustrating an operation process of an MS in a BWA communication system according to the present invention.

Referring to FIG. 4, the MS receives a DL_MAP message containing the actual frame number (second frame number) from the BS in step 401. Then in step 403, the MS recognizes the actual frame number of the BS set in the DL_MAP message. That is, the MS recognizes the actual frame number of the BS set in the PHY synchronization field of the DL_MAP message in step 403. Then in step 405, the MS performs, together with two or more BSs, randomization in the DL and UL by using the actual frame number and IDcell. At this time, the MS performs different randomizations for the BSs because the frame numbers of the BSs have not been synchronized.

Hereinafter, a more detailed description will be given of the randomization according to the present invention. In the case of subcarrier randomization in modulation of the BWA communication system, modulation in each BS is randomized by a specific Pseudo-Random Bit Sequence (PRBS) of the BS. For example, it is assumed that an initialization vector of the PRBS includes a total of eleven bits as shown in Table 6 below:

TABLE 6
b0 ˜ b4: downlink - five Least Significant Bits (LSBs) of IDcell in the
first PUSC zone
or DL_{—PermBase in other zones, and}

uplink - five LSBs of IDcell;
b5 ˜ b6: downlink - segment number + 1, and
uplink - 0b11, that is, all bits have a value of 1; and

b7 ˜ b10: downlink - 0b1111, that is, all bits have a value of 1, and

uplink - four LSBs of frame numbers.

Then, in the case of downlink, which has 32 types of IDcell or PermBase and three types of segment numbers, total 96 initialization vectors are generated. In the case of UL, in which the initialization vectors are generated by the IDcell and frame numbers, total 32 types of initialization vectors are generated when the frame numbers of the BSs have been synchronized. Therefore, it is possible to generate 32 types of PRBSs in the UL, and the possibility that two or more adjacent BSs may perform the same randomization thus becomes three times higher in the UL than in the DL. However, because the actual frame numbers of the BSs have not been synchronized and there are three types of segment numbers, 96 initialization vectors are generated. Therefore, it is possible to generate 96 types of PRBSs in the UL, and the possibility that two or more adjacent BSs may perform the same randomization is thus the same in the UL as in the DL.

For example, when b0˜b10 of a BS is “10101010101,” the initialization sequence is “101010101000000000 . . . . ” When the initialization sequence is subjected to a PRBS generator having a predetermined polynomial, a randomization sequence of the corresponding BS is produced. If the produced randomization sequence is put as w0, w1, w2, . . . , randomization sequences as many as available sub-carriers are generated and used for randomization of the modulation. In the case of 1024 Fast Fourier Transform (FFT) and PUSC, a sequence of w0, w1, . . . , w840 is used for the first symbol, and a sequence of w1, w2, . . . , w841 is used for the second symbol. Further, a data block having been subjected to repetition of the randomization sequence is subjected to a constellation mapping and is then mapped to physical sub-carriers. At this time, for each sub-carrier before the physical sub-carrier mapping, a predetermined factor is multiplied by the constellation.

As a result, the randomizations by two or more BSs are different from each other, and the constellation mappings of the BSs are also different from each other. When the constellation mappings of the BSs are different from each other, the performance in pilot estimation during the demodulation is improved. In other words, in the uplink, each MS transmits the pilot at the same position, and the pilot signal is determined by the randomization sequence, that is, wₖ. Therefore, each MS served by different BSs transmits pilots having different sequences, so that the pilot estimation by the BSs is improved and the demodulation performance is correspondingly improved.

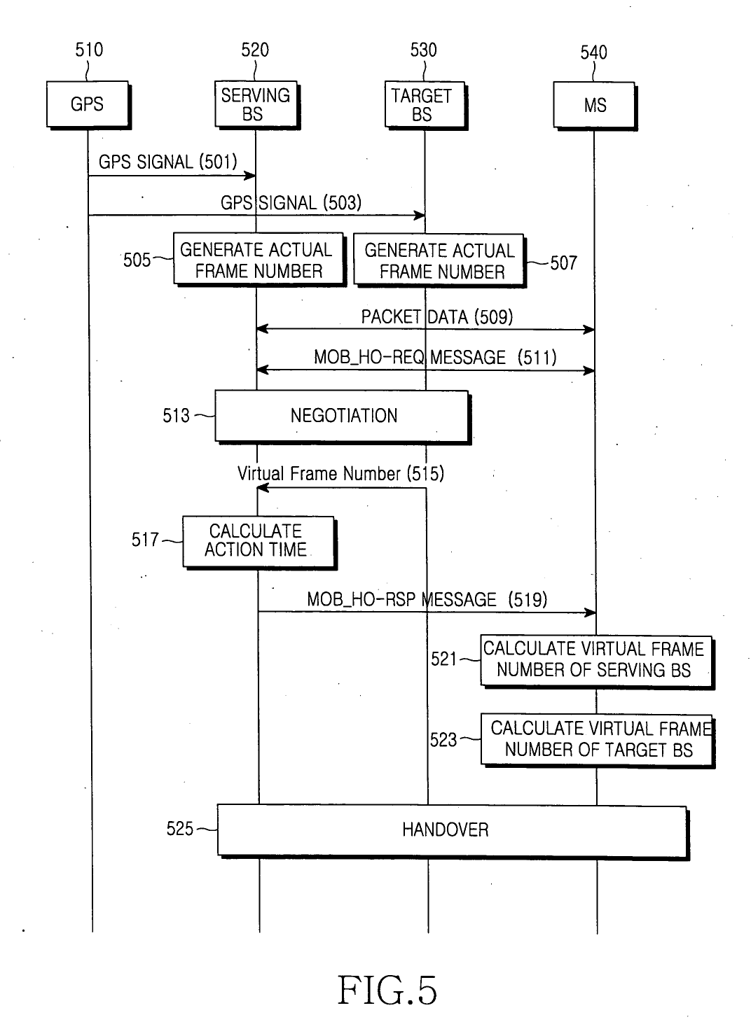

FIG. 5 is a flow diagram illustrating a handover process in a BWA communication system according to the present invention. FIG. 5 illustrates transmission/reception of signals for handover when an MS 540 receiving a service from a current serving BS 520 moves from the cell controlled by the current serving BS 520 to a neighbor cell controlled by a target BS 530.

Referring to FIG. 5, the serving BS controlling the cell in which the MS 540 is located and the target BS 530 controlling the cell to which the MS will move receive a GPS signal from a GPS transmitter (e.g., satellite) 510 at each frame (steps 501 and 503, respectively). Then, the serving BS 520 and the target BS 530 generate a virtual frame number (first frame number) at each frame by using the received GPS signal, and then generate actual frame numbers (second frame numbers) by adding predetermined segment numbers of the BSs to the generated virtual frame number (steps 505 and 507, respectively). In the generated actual frame numbers, which are the frame numbers of the BSs 520 and 530, the virtual frame number is used for synchronization between the frame numbers of the BSs 520 and 530 and the segment numbers are used to prevent synchronization between the frame numbers of the BSs 520 and 530.

Thereafter, because the serving BS 520 is providing a service to the MS 540 as assumed above, the serving BS 520 and the MS 540 exchange packet data (step 509). While the serving BS 520 and the MS 540 exchange packet data, if the MS 540 moves from a cell controlled by the serving BS 520 to a cell controlled by the target BS 530 and it is thus necessary to perform handover, the MS 540 transmits a Mobile Handover Request (MOB_HO-REQ) message to the serving BS 520 (step 511). Upon receiving the MOB_HO-REQ message, the serving BS 520 performs negotiation with the target BS 530 in step 513.

Then, through a backbone of the system, the target BS 530 must inform the serving BS 520 of the time point for sending a Fast_Ranging-IE message including a fast information element (Fast_Ranging-IE) to the MS 540, so that the target BS 530 can perform fast ranging during the handover. Then, the target BS 530 transmits the virtual frame number in the actual frame number generated in step 507 to the serving BS 520 (step 515). The virtual frame number is used as a reference for the time point for transmitting the Fast_Ranging-IE message to the MS 540. Because the virtual frame number is a frame generated by using the same GPS signal received by both the serving BS 520 and the target BS 530 and has thus been synchronized, it is unnecessary to calculate a separate time offset between the serving BS 520 and the target BS 530.

After receiving the virtual frame number from the target BS 530, the serving BS 520 calculates action time by using a difference between the received virtual frame number and another virtual frame number generated by using a GPS signal received from the GPS 510 at the current frame (step 517). After calculating the action time, the serving BS 520 sets the action time in a Mobile Handover Response (MOB_HO-RSP) message corresponding to the MOB_HO-REQ message and transmits the MOB_HO-RSP message to the MS 540 (step 519). The MOB_HO-RSP message transmitted to the MS 540 contains the actual frame number of the serving BS 520 generated in step 505.

After receiving the MOB_HO-RSP message, the MS 540 calculates the virtual frame number of the serving BS 520 by using Equation (3) below.
Virtual Frame Number=Actual Frame Number−Segment Number (3)

In Equation (3), the actual frame number is set in and carried by the MOB_HO-RSP message, and the segment number is a predetermined specific parameter of each BS and is transmitted to the MS 540 through a preamble PN code of the serving BS 520.

After calculating the virtual frame number, the MS 540 calculates an actual frame number of the target BS 530, that is, an actual frame number (N_Fast-Ranging) for receiving the Fast_Ranging-IE message, by using Equation (4) defined below (step 523).
N_Fast-Ranging=Virtual Frame Number+Action Time+Segment Number (4)

The virtual frame number in Equation (4) refers to the virtual frame number of the serving BS 510 calculated by Equation (3), which serves as a reference for the synchronization time between the serving BS 520 and the target BS 530. Further, the action time refers to the offset of the frame for receiving the GPS signal in order to generate the virtual frame number of the serving BS 520 and the target BS 530. Further, the segment number refers to a predetermined specific parameter of each BS and is transmitted through the preamble PN code of the target BS 530 to the MS 540. At this time, the MS 540 has already recognized the segment number of the target BS 530 as assumed above.

After calculating and recognizing the time point for receiving the Fast_Ranging-IE message including the fast ranging information from the target BS 530, the MS 540 receives the Fast_Ranging-IE message at the time point and performs the handover process (step 525). In other words, in a BWA communication system according to the present invention, frame numbers of the serving BS 520 and the target BS 530 are first synchronized, and the MS 540 then recognizes the time point for transmission of the Fast_Ranging-IE message for fast ranging by the target BS 530. Then, the time point for transmission of the Fast_Ranging-IE message can be recognized by using the synchronized frame number between the serving BS and the target BS, that is, the virtual frame number, as reference time, so that the communication system can perform handover at a high speed.

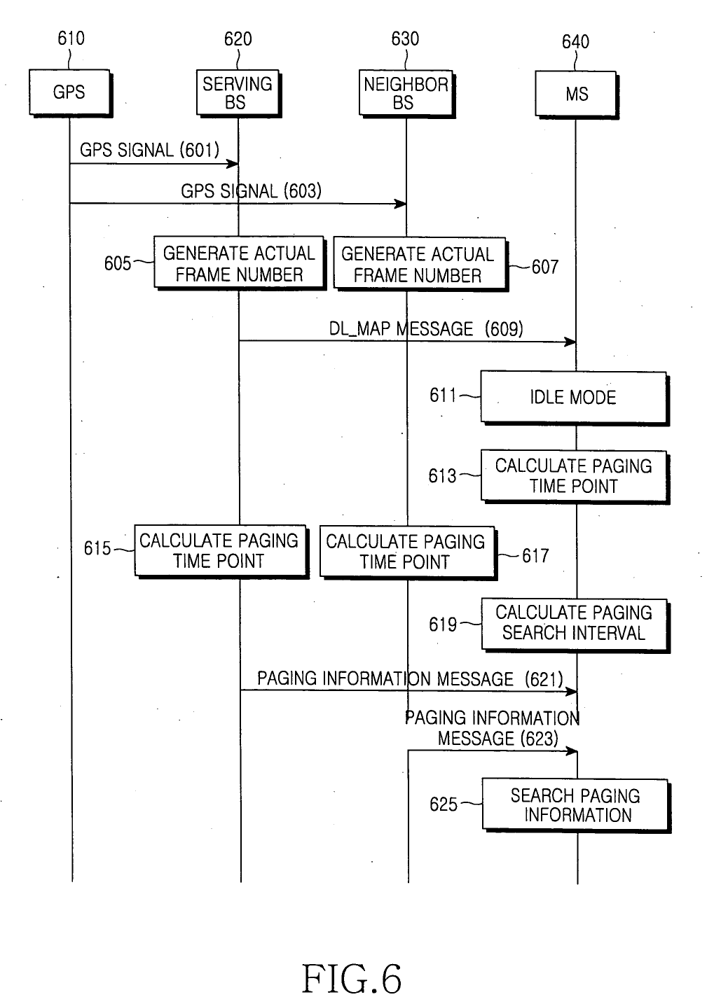

FIG. 6 is a flow diagram of a paging process by an MS in an idle mode in a BWA communication system according to the present invention. FIG. 6 illustrates transmission/reception of signals for paging when an MS 640, which is in an idle mode moves from the cell controlled by current serving BS 620 to a neighbor cell controlled by a target BS 630.

Referring to FIG. 6, the serving BS controlling the cell in which the MS 640 is located and the neighbor BS 630 controlling the cell to which the MS will move receive a GPS signal from a GPS transmitter 610 at each frame (steps 601 and 603, respectively). Then, the serving BS 620 and the neighbor BS 630 generate a virtual frame number (first frame number) at each frame by using the received GPS signal, and then generate actual frame numbers by adding predetermined segment numbers to the generated virtual frame number (steps 606 and 607, respectively). In the generated actual frame numbers, which are the frame numbers of the BSs 620 and 630, the virtual frame number is used for synchronization between the frame numbers of the BSs 620 and 630 and the segment numbers are used to prevent synchronization between the frame numbers of the BSs 620 and 630.

Thereafter, because the MS 640 is located within the cell controlled by the serving BS 620 as assumed above, the MS 640 receives the DL_MAP message from the serving BS 620 (step 609). The DL_MAP message has a format as shown in Table 2, which includes the actual frame number of the serving BS 605 generated in step 605. Then, when there is no traffic between the MS 640 and the serving BS 520, the MS 640 stays in the idle mode in order to prevent power loss of the MS 640 as described above (step 611). Then, the MS 640 calculates the time point for paging by using the actual frame number of the serving BS 620 set in the DL_MAP message received from the serving BS 620 (step 613). Further, the serving BS 620 and the neighbor BS 630 calculate the time point for paging by using their actual frame numbers generated in steps 605 and 607, respectively (steps 615 and 617, respectively).

Then, the MS 640 recognizes the segment number from the preamble PN code of the serving BS 620 and then calculates a paging search interval by using the segment number and the paging time point calculated in step 613 (step 619). In calculating the paging search interval, the MS 640 takes a difference between the actual frame number of the neighbor BS 630 and the actual frame number of the serving BS 620, and the paging search interval is determined as an interval from a frame before a difference between the segment number and a predetermined factor at the paging time point to a frame after the segment number in a predetermined paging interval. The predetermined factor has a value of 2 because the segment number, which is a specific parameter of each BS as described above, has one value from among 0, 1, and 2. Further, the predetermined paging interval has a value set in advance by the user.

After the MS 640 calculates the paging search interval, the serving BS 620 and the neighbor BS 630 determine if there is paging information of the MS 640. When there is paging information of the MS 640, the serving BS 620 and the neighbor BS 630 transmit to the MS 640 the paging information which they have confirmed in the predetermined paging interval from the paging time point (steps 621 and 623). Then, in step 625, the MS 640 searches for the paging information during the paging search interval calculated in step 619. As a result of the search, the MS 640 transits into the awake mode when there is paging information. In contrast, when there is no paging information, the MS 640 calculates the paging time point again.

In a communication system according to the present invention as described above, a first frame number is used to synchronize the frame numbers of the BSs and a second frame number is used to prevent synchronization between the frame numbers of the BSs. Therefore, the present invention has both advantages due to the synchronization between the frame numbers of the BSs, for example, advantages when the MS moves between cells controlled by different BSs, and advantages when the synchronization between the frame numbers of the BSs is prevented, for example, advantages in the case of randomization. As a result, the present invention can prevent errors in operation of the communication system and can reduce data loss and unnecessary operation of the system, thereby reducing the power consumption of the system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for synchronizing in a communication system, the method comprising:
receiving, by a base station, a reference signal from an external system and generating a first frame number according to the received reference signal; and
generating a second frame number by adding a specific number for each base station of a plurality of base stations to the first frame number, and broadcasting a message setting second frame number to mobile stations.

2. The method as claimed in claim 1, wherein the reference signal is transmitted from a Global Positioning System (GPS) and includes temporal information.

3. The method as claimed in claim 1, wherein the first frame number is generated according to the reference signal to be a frame number by which the plurality of base stations are synchronized.

4. The method as claimed in claim 3, wherein the specific number is an offset determined in advance for each base station of the plurality of base stations.

5. The method as claimed in claim 4, wherein the second frame number is generated by adding the offset to the first frame number to be a frame number by which base stations are not synchronized.

6. The method as claimed in claim 1, wherein broadcasting the message comprises setting the generated second frame number in a physical synchronization field of the message and broadcasting the message to the mobile stations.

7. The method as claimed in claim 1, further comprising:
negotiating with a target base station, which controls a cell to which a predetermined mobile station will move, and receiving a first frame number of the target base station from the target base station by a serving base station, which currently provides a communication service to the predetermined mobile station, when the serving base station has received a handover request message from the predetermined mobile station from among the plurality of mobile stations;
calculating action time from a difference between a first frame number of the target base station and a first frame number of the serving base station and setting the calculated action time in a handover response message in response to the handover request message; and
transmitting the handover response message to the predetermined mobile station, calculating the first frame number of the serving base station and the second frame number of the target base station, and performing handover.

8. The method as claimed in claim 7, wherein setting the calculated action time in the handover response message comprises further setting a second frame number of the serving base station in the handover response message.

9. The method as claimed in claim 7, wherein calculating the second frame number of the target base station comprises calculating, by the predetermined mobile station, the second frame number of the target base station from which the predetermined mobile station will receive ranging information.

10. The method as claimed in claim 1, further comprising:
calculating a paging time point according to the second frame number when a predetermined mobile station from among the plurality of mobile stations transitions into an idle mode; and
transmitting paging information of the predetermined mobile station to the predetermined mobile station from the calculated paging time point when there is the paging information of the predetermined mobile station.

11. A method for synchronizing in a communication system, the method comprising:
receiving messages from base stations by a mobile station, wherein each of messages includes a second frame number generated by adding a specific number for each base stations to a first frame number; and
recognizing the second frame number and performing randomization according to the second frame number.

12. The method as claimed in claim 11, wherein the first frame number is generated according to a signal including temporal information transmitted from a Global Positioning System (GPS) and is used for synchronization with neighbor base stations by the each base stations.

13. The method as claimed in claim 12, wherein the specific number is an offset determined in advance for the each base stations.

14. The method as claimed in claim 13, wherein the second frame number is generated by adding the offset to the first frame number and is used to prevent synchronization with the neighbor base stations by the each base stations.

15. The method as claimed in claim 11, wherein recognizing the second frame number comprises recognizing set the generated second frame number in a physical synchronization field of the message.

16. The method as claimed in claim 11, further comprising:
transmitting a handover request message to a serving base station, which currently provides a communication service to the mobile station, when it is determined that the mobile station must handover; and
receiving a handover response message in which an action time is set in response to the handover request message, calculating a first frame number of the serving base station and a second frame number of a target base station from the received handover response message, and performing handover, wherein the target base station controls a cell to which the mobile station will move.

17. The method as claimed in claim 16, wherein receiving the handover response message comprises calculating the first frame number of the serving base station and the second frame number of a target base station according to the action time.

18. The method as claimed in claim 16, wherein receiving the handover response message comprises receiving the handover response message in which a second frame number of the serving base station is further set.

19. The method as claimed in claim 16, wherein calculating the second frame number of the target base station comprises calculating the second frame number of the target base station from which the mobile station will receive ranging information.

20. The method as claimed in claim 11, further comprising:
calculating a paging time point according to a second frame number of a serving base station, which currently provides a communication service to the mobile station, when the mobile station transitions into an idle mode, and calculating a paging information search interval from a difference between the second frame number of the serving base station and a second frame number of neighbor base station; and
searching for paging information of the mobile station during the paging information search interval from the calculated paging time point.

21. A method for synchronizing in a communication system, the method comprising:
receiving, by a base station, reference information from an external system and generating a message according to the reference information and predetermined information for each base stations of a plurality of base stations; and
broadcasting the generated message to the plurality of mobile stations.

22. The method as claimed in claim 21, wherein the reference information is temporal information transmitted from a Global Positioning System (GPS).

23. The method as claimed in claim 21, wherein generating the message comprises generating a first frame number according to the reference information for synchronization between the base stations, and a second frame number according to the first frame number and the predetermined information, the message is included the second frame number.

24. The method as claimed in claim 23, wherein the predetermined information is an offset determined in advance for the each base stations.

25. The method as claimed in claim 24, wherein the second frame number is generated by adding the offset to the first frame number and is used to prevent synchronization between the each base stations.

26. The method as claimed in claim 23, wherein broadcasting the message comprises setting the second frame number in a physical synchronization field of the message and broadcasting the message the mobile stations.

27. A system for synchronizing in a communication system, the system comprising:
a base station for generating a first frame number according to a reference signal when the base station receives the reference signal from an external system, generating a second frame number by adding a specific number for each base stations of a plurality of base stations to the first frame number, and broadcasting a message setting the generated second frame number to a plurality of mobile stations; and
a mobile station for recognizing the second frame number set in the message when the mobile station receives the message from the base station, and performing randomization according to the second frame number.

28. The system as claimed in claim 27, wherein the reference signal is transmitted from a Global Positioning System (GPS) and includes temporal information.

29. The system as claimed in claim 27, wherein the base station generates the first frame number according to the reference signal, so that the first frame number is used for synchronization between the each base stations.

30. The system as claimed in claim 29, wherein the specific number is an offset determined in advance for the each base stations.

31. The system as claimed in claim 30, wherein the base station generates the second frame number by adding the offset to the first frame number, so that the second frame number is used to prevent synchronization between the each base stations.

32. The system as claimed in claim 27, wherein the base station sets the generated second frame number in a physical synchronization field of the message and broadcasts the message to the mobile stations.

33. The system as claimed in claim 27, wherein:
a serving base station negotiates with a target base station and receives a first frame number of the target base station from the target base station when the serving base station receives a handover request message from a predetermined mobile station from among the plurality of mobile stations, calculates an action time from a difference between a first frame number of the target base station and a first frame number of the serving base station, sets the calculated action time in a handover response message in response to the handover request message, and transmits the handover response message to the predetermined mobile station, wherein the serving base station corresponds to a base station currently providing a communication service to the predetermined mobile station and the target base station corresponds to a base station controlling a cell to which the predetermined mobile station will move; and
the mobile station receives the handover response message, calculates the first frame number of the serving base station and a second frame number of the target base station from the received handover response message, and then performs handover.

34. The system as claimed in claim 33, wherein the serving base station further sets a second frame number of the serving base station in the handover response message.

35. The system as claimed in claim 33, wherein the predetermined mobile station calculates the second frame number of the target base station from which the predetermined mobile station will receive ranging information.

36. The system as claimed in claim 27, wherein:
the base station calculates a paging time point according to the second frame number when a predetermined mobile station from among the plurality of mobile stations transition into an idle mode, and transmits paging information of the predetermined mobile station to the predetermined mobile station from the calculated paging time point when there is the paging information of the predetermined mobile station; and
the mobile station calculates a paging time point according to a second frame number of a serving base station, which currently provides a communication service to the mobile station, when the mobile station transition into an idle mode, calculates a paging information search interval from a difference between the second frame number of the serving base station and a second frame number of neighbor base station, and searches for paging information of the mobile station during the paging information search interval from the calculated paging time point.

37. A system for synchronizing in a communication system, the system comprising:
a base stations for receiving a reference information from an external system and generating a message according to the reference information and predetermined information for each base stations of a plurality of base stations; and broadcasting the generated message to the plurality of mobile stations.

38. The system as claimed in claim 37, wherein the reference information is temporal information transmitted from a Global Positioning System (GPS).

39. The system as claimed in claim 37, wherein the base station generates a first frame number according to the reference information for synchronization between the base stations, and a second frame number according to the first frame number and the predetermined information, the message is included the second frame number.

40. The system as claimed in claim 39, wherein the predetermined information is an offset determined in advance for the each base stations.

41. The system as claimed in claim 40, wherein the second frame number is generated by adding the offset to the first frame number and is used to prevent synchronization between the each base stations.

42. The system as claimed in claim 39, wherein the base station sets the second frame number in a physical synchronization field of the message and broadcasts the message the mobile stations.
